(19) United States
(12) Patent Application Publication
(10) Pub. No.: US 2026/0254656 A1
(43) Pub. Date: Aug. 27, 2026

(54) ENTERPRISE CONTROLLED AUTHENTICATION

(71) Applicant: Visa International Service Association, San Francisco, CA (US)

(72) Inventor: Eric Le Saint, Los Altos, CA (US)

(73) Assignee: Visa International Service Association, San Francisco, CA (US)

(21) Appl. No.: 19/163,086

(22) PCT Filed: Mar. 29, 2024
(86) PCT No.: PCT/US2024/022283

§ 371 Date: Sep. 8, 2025

Related U.S. Application Data
(60) Provisional application No. 63/455,419, filed on Mar. 29, 2023.

(51) Int. Cl. H04L 9/32

(52) U.S. Cl. CPC H04L 9/3247; H04L 9/3231; H04L 9/3271

(57) ABSTRACT

A method includes transmitting a challenge to a server as part of a request for a service provided by the server. The method further includes receiving, a signed response, wherein the signed response was generated using the challenge and is signed with a private key of the server. The method further includes, responsive to receiving the signed response, verifying the signed response with a public key corresponding to the private key of the server, the public key corresponding to a first mode of the authenticator device. The method further includes responsive to verifying the signed response, switching a current mode of the authenticator device to the first mode corresponding to the public key. The method further includes providing a second request to a user of the authenticator device to authenticate using one or more authentication factors corresponding to the first mode.

### CROSS-REFERENCES TO RELATED APPLICATIONS

This application is a PCT application which claims priority to U.S. Provisional Application No. 63/455,419, filed on Mar. 29, 2023, which is herein incorporated by reference in its entirety.

### BACKGROUND

Authenticator devices can provide privacy and anonymity to the user of the authenticator device while also allowing a system to authenticate a user of the authenticator device by using the authenticator device. In an example, when registering a user identity to a website service, an authenticator device (e.g., a FIDO device) may generate a passkey for the website service. As a result, a unique passkey including a public key and private key can be used to authenticate the authenticator device for each service the authenticator device is registered with. As a result, the identity of the authenticator device user can remain private to the website service as each service the authenticator device is registered with receives a different passkey. However, if the authenticator device is given/transferred to a different user, the website service may not know that the user of the authenticator device has changed and may not be able to prevent such a transfer. Furthermore, the website service may not be able to control which other services the passkey associated with the website service could be exposed to.

Embodiments of the disclosure address this problem and other problems individually and collectively.

### BRIEF SUMMARY

One embodiment of the present disclosure includes a method. The method comprises: transmitting a challenge to a server as part of a request for a service provided by the server; receiving, a signed response, wherein the signed response was generated using the challenge and is signed with a private key of the server; and responsive to receiving the signed response, verifying the signed response with a public key corresponding to the private key of the server, the public key corresponding to a first mode of the authenticator device; responsive to verifying the signed response, switching a current mode of the authenticator device to the first mode corresponding to the public key; and providing a second request to a user of the authenticator device to authenticate using one or more authentication factors corresponding to the first mode.

One embodiment of the present disclosure includes an authenticator device. The authenticator device comprising: a processor; and a computer readable medium comprising code executable by the processor causing the authenticator device to: transmitting a challenge to a server as part of a request for a service provided by the server; receiving, a signed response, wherein the signed response was generated using the challenge and is signed with a private key of the server; and responsive to receiving the signed response, verifying the signed response with a public key corresponding to the private key of the server, the public key corresponding to a first mode of the authenticator device; responsive to verifying the signed response, switching a current mode of the authenticator device to the first mode corresponding to the public key; and providing a second request to a user of the authenticator device to authenticate using one or more authentication factors corresponding to the first mode.

These and other embodiments are described in further detail below.

### BRIEF DESCRIPTION OF THE DRAWINGS

FIG. 1 illustrates a system with an authenticator device, according to an embodiment.

FIG. 2 illustrates a system, according to an embodiment.

FIG. 3 illustrates a system, according to an embodiment.

FIG. 4 illustrates a flow diagram where external authentication occurs, according to an embodiment.

FIG. 5 illustrates a system with security level control, according to an embodiment.

FIG. 6 illustrates a system 600 for supervised authentication factor enrollment, according to an embodiment.

FIG. 7 illustrates a computer system that may be used with embodiments of the present disclosure.

### TERMS

Prior to discussing embodiments of the disclosure, some terms can be described in further detail.

A “user” may include an individual. In some embodiments, a user may be associated with one or more personal accounts and/or mobile devices. The user may also be referred to as an employee, account holder, or consumer in some embodiments.

An “authenticator device” may be a device that is capable of authenticating a user. The authenticator device may be able to authenticate a user through the use of one or more authentication techniques, such as a PIN, password, biometrics, supervised biometrics, etc. Further, the authenticator device may be able to prove that a user has been authenticated with the use of a key that is stored by the authenticator device (e.g., a private key, a public key, an external authentication public key, etc.). An example of an authenticator device is a FIDO device, which may also be referred to as a FIDO enterprise device. An authenticator device may also be included in a mobile phone, a tablet, a laptop, a desktop computer, a smartwatch, a universal serial bus (USB) device, or other electronic devices.

A “mode” of an authenticator device may cause a configuration of the authenticator device. The authenticator device may include any number of modes. When an authenticator device is in a particular mode, the authenticator device can access particular private key(s) associated with the particular mode but be prevented from accessing other private key(s) associated with another mode, and vice versa when in the other mode. Each mode of the authenticator device may be associated with any number of authentication factors that cause the authenticator device to enter the mode and/or access private keys associated with the mode. The authenticator device may include a default mode that the authenticator device enters into after a condition occurs, e.g., after a private key is used to sign a message, after a set amount of time, when authentication of a relying party system fails, when the authenticator device is communicating with or not communicating with a specific client device, after the authenticator device is powered ON, etc. The mode of the authenticator device may be set according to a relying party system the authenticator device is authenticating to, a relying party system authenticating to the authenticator device, when used with a specific client device, a message received by the authenticator device (e.g., a signed response message), authentication factors used with the authenticator device, authentication input received by the authenticator device, based on a user mode selection, etc.

A “relying party system” may be a system that is reliant upon the use of an authenticator device to authenticate the user with the relying party system. A relying party system may be controlled by a person or entity. The relying party system may use one or more FIDO services to allow authenticator devices to authenticate with the relying party system.

A “resource” can be something of value to a user. A resource, for example, can include digital items and/or physical items. A resource can be an obtainable item. A resource can be owned by an entity. A resource can be a physical item such as goods. A resource can be a service that is provided by a merchant. A resource can be a digital item such as non-fungible tokens, secure data, etc. Another example of a resource is access to a secure or otherwise access-controlled location.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “credential” may be any suitable information that serves as reliable evidence of worth, ownership, identity, or authority. A credential may be a string of numbers, letters, or any other suitable characters that may be present or included in any object or document that can serve as confirmation. User credential examples can be a primary account number, driver's license ID, social security number, etc.

### DETAILED DESCRIPTION

Self-managed employee credentials present a significant risk and may not be an acceptable response to the increase in account takeover and social engineering threats that are being observed. Dark web actors are now organized to monetize employee credentials and broker enterprise access to criminal actors. Most employees are not capable of reliably protecting themselves against the sophisticated forms of social engineering that have been reported and documented. If a compromised credential is bound to a privileged account, it may result in an unacceptable loss or impact for the enterprise, or the community or customers that it serves.

Current solutions are too limiting, with only one external authentication (Ext-Auth) public key to access one domain, network, relying party system (e.g., server), etc.

Embodiments of the present disclosure can allow for an authenticator device (e.g., a FIDO device, FIDO enterprise device, etc.) to control its connectivity to any number of authorized domains across multiple organizations. Further, embodiments described herein, allow for an enterprise to control employee account authentication credentials (e.g., A FIDO authenticator, an enterprise FIDO authenticator, etc.). Embodiments allow for the external authentication (Ext-Auth) function of an authenticator device (e.g., FIDO device) to cryptographically prove to a protected device process that the authenticator device is actually connected to an authorized enterprise domain (e.g., a network of systems with controlled configurations, centrally protected against malware and vulnerabilities, etc.). If the external authentication fails, the authenticator device is not activated to perform the basic authentication and registration, WebAuthN, protocol steps. As the authenticator device is practically unusable, the exposure to threats (e.g., key loggers, man-in-the-middle attacks, etc.) can be greatly reduced.

### I. Authenticator Devices

Authenticator devices can be used to authenticate a user through the use of one or more authentication techniques, such as a PIN, password, biometrics, supervised biometrics, etc.

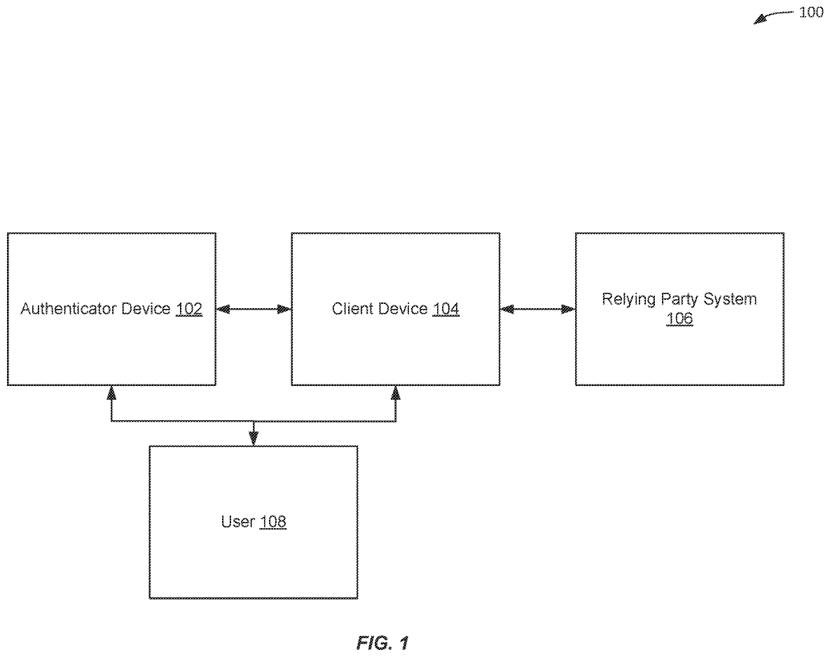

FIG. 1 illustrates a system 100 with an authenticator device 102, according to an embodiment. The system 100 also includes a client device 104 (e.g., a browser) and a relying party system 106. The authenticator device 102 may be used to authenticate a user 108 and cause the relying party system 106 to allow the user 108 and/or a system associated with the user 108 access to a resource. The authenticator device 102 can use a key pair (e.g., public-private keypair) enrolled with the relying party system 106 to authenticate the user 108 to the relying party system 106. The key pair can also be referred to as a passkey and may be unique to a service of the relying party system 106. Unlike passwords, a passkey can be resistant to phishing, is generally stronger, and is designed so that there are no shared secrets.

As an example, a user 108 may use a client device 104 to access a relying party system 106 (e.g., a web server). The relying party system 106 may request that the user 108 be authenticated before access to a resource controlled by the relying party system 106 is granted to the user 108. The authenticator device 102 can authenticate the user 108 using one or more authentication factors (e.g., a PIN, a password, biometrics, etc.).

An authentication factor may include a known reference value (e.g., “1234,” “password,” etc.) to be compared with user authentication input (e.g., PIN data, password data, fingerprint data) obtained using one or more user interfaces (e.g., number pad, fingerprint scanner, keypad, a touchscreen, a microphone, etc.). After receiving authentication input from the user 108 to be authenticated, the authenticator device 102 can compare the authentication input against the known reference value of one or more authentication factors to determine if the user 108 can be authenticated. If the authentication input is sufficiently close (e.g., matches, 95% similar) to the known reference value of the authentication factor, the user 108 can be determined to be authenticated.

Once the authenticator device 102 authenticates the user 108, a private key associated with the authenticator device 102 and an account of the user 108 accessible to the relying party system 106 may be used to sign a message that is transmitted to the relying party system 106. The relying party system 106 can authenticate the user 108 based on the signature generated using the private key corresponding to a public key accessible to the relying party system 106 and associated with an account of the user 108. After the relying party system 106 determines private key signature transmitted from the authenticator device 102 corresponds to the public key, the relying party system 106 may grant the user 108 and/or user device (e.g., authenticator device 102 and/or client device 104) access to a resource.

The authenticator device 102, may be used to authenticate the user 108. Authentication of the user 108 may be requested (e.g., via the client device 104) before the user 108 or a system associated with the user 108 can access a resource controlled by the relying party system 106. The authenticator device 102 can authenticate the user 108 by signing a message with a private key after the user 108 uses one or more user interfaces to provide authentication input (a PIN, a password, a biometric, and/or other method of authentication) to the authenticator device 102 to be compared with one or more authentication factors of the authenticator device 102.

The client device 104 can be used to facilitate communication between the authenticator device 102 and the relying party system 106. The client device 104 can be used to request access to the relying party system 106 and transmit signed messages to and from the authenticator device 102 and relying party system 106 so that the relying party system 106 can determine whether the user 108 of the authenticator device 102 has been authenticated for access to the relying party system 106.

The relying party system 106 may manage one or more resources. The relying party system 106 may manage one or more public keys. The public keys may pair with a private key stored by respective user devices. The relying party system 106 may receive a resource access request from the authenticator device 102. The relying party system 106 may request that the user 108 be authenticated before access to resources of the relying party system 106 is granted.

### II. Using an Authenticator Device

As described above, an authenticator device may be used to authenticate a user and cause the relying party system to allow the user and/or a system associated with the user access to a resource. The authenticator device can use a passkey/key pair (e.g., public-private keypair) enrolled with the relying party system to authenticate the user to the relying party system. Before an authenticator device can be used, the authenticator device must be enrolled with the relying party system. After the authenticator device is enrolled with the relying party system, the authenticator device can be used.

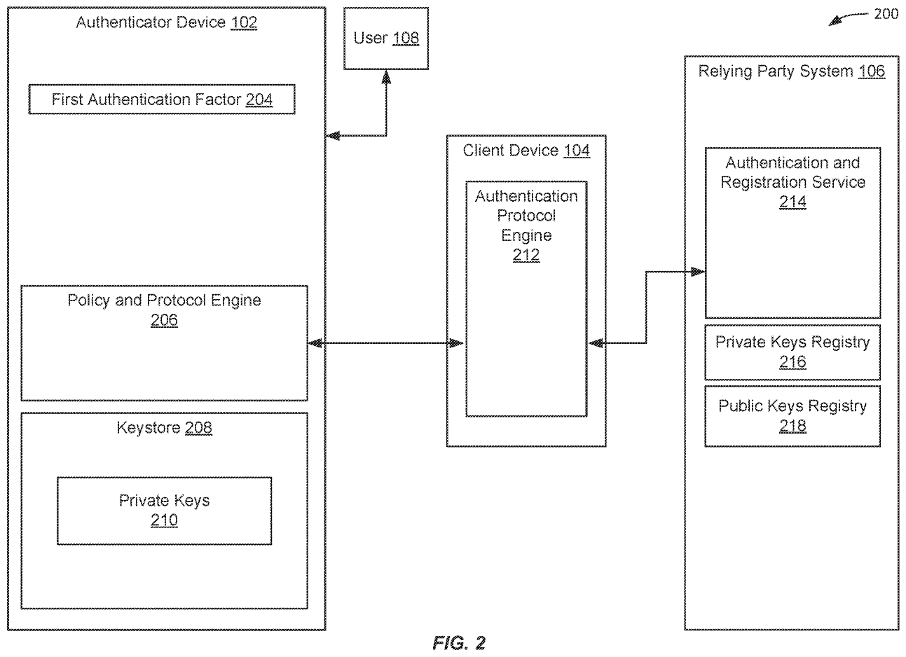

FIG. 2 illustrates a system 200, according to an embodiment. The system includes an authenticator device 102, a client device 104, and a relying party system 106.

### A. Enrolling a Key Pair With a Relying Party System

System 200 includes a keystore 208 to store private keys 210 associated with a passkey enrolled with the relying party system 106. System 200 includes a public keys registry 218 to store public keys associated with the passkey enrolled with the relying party system 106. The private keys 210 may be accessed based on one or more authentication factors (e.g., the first authentication factor 204) being satisfied by authentication input.

A user 108 may set up one or more authentication factors to use with the authenticator device (e.g., a first authentication factor 204). The first authentication factor 204 may be generated using a password, a biometric, a PIN, a button press, a supervised biometric, etc. The authentication factor(s) (e.g., biometric measurements or templates) may remain in memory of the authenticator device 102 and not be transmitted to another system (e.g., the relying party system 106).

Before an authenticator device 102 uses a passkey enrolled with the relying party system 106 to authenticate the user 108 to the relying party system, the authenticator device 102 must have access to the passkey enrolled with the relying party system 106. An example of a relying party system 106 is a web server.

The authenticator device 102 can generate a public key and a private key to include in the passkey key pair. The private key may be stored in the keystore 208 of the authenticator device. The private key may be stored in a portion of the keystore 208 specifically meant to store private keys 210 for the authenticator device 102. The passkey may be unique to the authenticator device 102. The passkey may be generated based on a seed, a random number, and/or features of the first authentication factor 204 (e.g., information included in a biometric sensor measurement). In certain embodiments, the public key of the passkey may be transmitted to one or more relying party systems 106 to be associated with an account associated with the authenticator device 102 and/or the user 108 of the authenticator device 102. The public key of the passkey may be stored in the keystore 208 and associated with the private key of the passkey.

After the public key of the passkey is transmitted to the relying party system 106, the public key may be stored in a public keys registry 218 of the relying party system 106.

The public keys registry 218 of the relying party system 106 may store any number of public keys received from authenticator devices. Each public key in the public keys registry 218 may be associated with a user account and/or an authenticator device 102.

The private key of the passkey may be retained by the authenticator device 102 and stored in the private keys 210 of the keystore 208. The private key may be associated with private key identification information (e.g., the user account) so that when a request to authenticate a user account is received from the relying party system 106, the corresponding private key can be searched for and used for authentication to the relying party system 106.

### B. Using a Passkey for Subsequent Sign-in to a Relying Party System

After a passkey from the authenticator device 102 has been enrolled with a relying party system 106 (e.g., as described above), the passkey may be used to authenticate the user 108 of a user account to the relying party system 106.

Upon accessing the relying party system 106 requesting access to a resource associated with a user account, the relying party system 106 may request that the user 108 be authenticated before access to a resource controlled by the relying party system 106 is granted to the user 108. Access to the relying party system 106 may be requested using a client device 104. The client device 104 may be a browser, a mobile application, etc. The client device 104 may be included in the same or different device as the authenticator device 102.

The relying party system 106 may request authentication from the authenticator device 102 by transmitting a challenge message to the authenticator device 102 via the client device 104.

The challenge message may indicate user account information for the user account that authentication is being requested for by the relying party system 106 (e.g., the user account associated with the resource). The challenge message may be transmitted by the authentication and registration service 214 to the authentication protocol engine 212 of the client device 104. Communication between the authentication and registration service 214 and the authentication protocol engine 212 may use a web authentication protocol (e.g., WebAuthn). The web authentication protocol (e.g., implemented via an application programming interface (API)) may be used by the client device 104 (e.g., a browser) to connect to the relying party system 106 that performs authentication of the authenticator device 102.

The web authentication protocol may use public key cryptography to protect communications from attacks. The web authentication protocol may use device-based authentication and can allow for passwords to remain local to a device instead of being transmitted. Since embodiments can allow for a user password not to be transmitted to the relying party system 106 for the user 108 of the authenticator device 102 to be authenticated at the relying party system 106, the confidentiality of the password can be increased. Further, the password does not need to be managed by the relying party system 106 and therefore the confidentiality of the password can be increased in this way. The web authentication protocol may be used to enroll new authenticator devices 102 with the relying party system 106 and may be used to perform authentication of existing authenticator device 102.

The authentication protocol engine 212 may transmit the challenge message to the policy and protocol engine 206. The authentication protocol engine 212 may communicate with the policy and protocol engine 206 using a Client to Authenticator Protocol (CTAP). Prior to executing a CTAP, the client device 104 and the authenticator device 102 may establish a confidential and mutually authenticated data transport channel with the client device 104. The CTAP can define how the client device 104 (e.g., a browser, mobile application, operating system) communicates with the authenticator device 102. The communications may be established over a wired (e.g., universal serial bus (USB)) or wireless (e.g., near field communication (NFC), Bluetooth low energy (BLE)) connection. For example, a wireless connection may be used when the client device 104 is not the same device as authenticator device 102. CTAP can be used in scenarios where a user interacts with a relying party system 106 (e.g., a website, a native application) on a platform (e.g., a laptop) which prompts the user to interact with the authenticator device 102 (e.g., a smartphone, a desktop computer, the laptop, a tablet, a USB key, a smartwatch, etc.) to authenticate the user.

In order to provide evidence of user interaction, the authenticator device 102 may include a user interface for authentication (e.g., a button, a switch, a sensor, a touchscreen, etc.) to receive the user interaction. User interactions can include any of the user input techniques described herein. The evidence of user interaction may include the same authentication factor(s) that was used during the enrollment process of the authenticator device 102 with the relying party system 106.

After the policy and protocol engine 206 receives a challenge message from the client device 104. The authenticator device 102 may be caused to prompt the user 108 of the authenticator device 102 for authentication input to satisfy the first authentication factor 204. The first authentication factor 204 to be satisfied may be based on information included in the challenge message and/or the first authentication factor 204 used during the enrollment process. Comparing authentication input to the first authentication factor 204 can enable the user 108 to authenticate themselves to the authenticator device 102, so that the authenticator device 102 may authenticate the user 108 with the relying party system 130 by using the client device 104 as a middleman for the communications.

Upon the first authentication factor 204 being satisfied (e.g., being sufficiently similar to the authentication input), the authenticator device 102 may be configured to access one or more private keys stored in the private keys 210. One or more keys included in the keystore 208 may only be accessible by the authenticator device 102 when the first authentication factor 204 has been satisfied. The one or more private keys accessible after the first authentication factor 204 has been satisfied may be used to sign a response message such that the relying party system 106 can verify that the user 108 of the authenticator device 102 has been authenticated. The response message may be a response to the challenge message. A specific private key may be accessed depending on the public key associated with the challenge message received by the policy and protocol engine 206 from the authentication protocol engine 212. The specific private key may be included in a passkey that is associated with a user account identified by the challenge message or associated with a resource of the relying party system 106 that access was requested.

The specific private key may be identified using private key identification information received by the authenticator device 102 from the relying party system 106. For example, the private key identification information may be used to look up a private key in a table that defines private key information and private key relationships. The challenge message from the relying party system 106 or another message from the relying party system 106 may include the private key identification information. Private key identification information from the relying party system 106 may include a relying party system identifier, a mode identifier, a user account identifier, and/or a public key identifier (e.g., the public key included in the passkey), etc.

The policy and protocol engine 206 may be used to transmit the response message signed using the private key to the authentication and registration service 214 via the client device 104.

The authentication and registration service 214 may evaluate user authentication information received from the authentication protocol engine 212 (e.g., via the signed response message) against a public key stored in the public key registry 218 to determine a validity of the signed response message. Responsive to the relying party system 106 determining the signed response message is valid based on the public key that corresponds to the private key used to sign the signed response message, access to one or more resources associated with a user account can be granted. The user account may be associated with the passkey.

The private keys registry 216 of the relying party system 106 may be used by the relying party system to store private keys that the relying party system 106 can use to sign messages before sending the messages. Private keys included in the private keys registry 216 may be uniquely identifiable (e.g., among all relying party systems). The private keys can be used to submit, to the relying party system 106, challenges and/or indications of private keys that are supported.

The following is an example of how system 200 may be used. In the example, a user 108 of an authenticator device 102 accesses the relying party system 106 via the client device 104 and requests access to a resource controlled by the relying party system 106. The user 108 may use the client device 104 to access the relying party system 106. In response, the relying party system 106 transmits an authentication request and a challenge to the authenticator device 102 via the client device 104. The challenge was signed by a public key included in the public keys registry 218 and associated with a pass key associated with the resource. The authenticator device 102 authenticates the user 108 using the first authentication factor 204 and authentication input received via a user interface of the authenticator device 102. Upon the authenticator device 102 authenticating the user 108 using the first authentication factor 204 and the authentication input, a private key included in the private keys 210 and corresponding to the public key (e.g., private key of the passkey) is used to sign a response message. The response message is transmitted from the authenticator device 102 to the relying party system 106 via the client device 104. Access to a resource may be provided after authentication of the user 108. The relying party system 106 may grant access to a resource if the response message is signed by the private key that corresponds to the public key used to sign the challenge message.

### III. Managing Keys With an Authenticator Device

Certain embodiments of the present disclosure enable an authenticator device to perform external authentication so that the authenticator device can authenticate the relying party before providing a signed message to the relying party. Additionally or alternatively, certain embodiments of the present disclosure enable an authenticator device to include multiple modes. Each mode may configure the authenticator device to use one or more private keys corresponding to the mode for signing a response message. A mode may be activated according to the relying party system the authenticator device is authenticating to, a relying party system authenticating to the authenticator device, when used with a specific client device, a message received by the authenticator device (e.g., a signed response message), mode identification information included in a message received by the authenticator device, authentication factors used with the authenticator device, authentication input, and/or based on a user mode selection, etc.

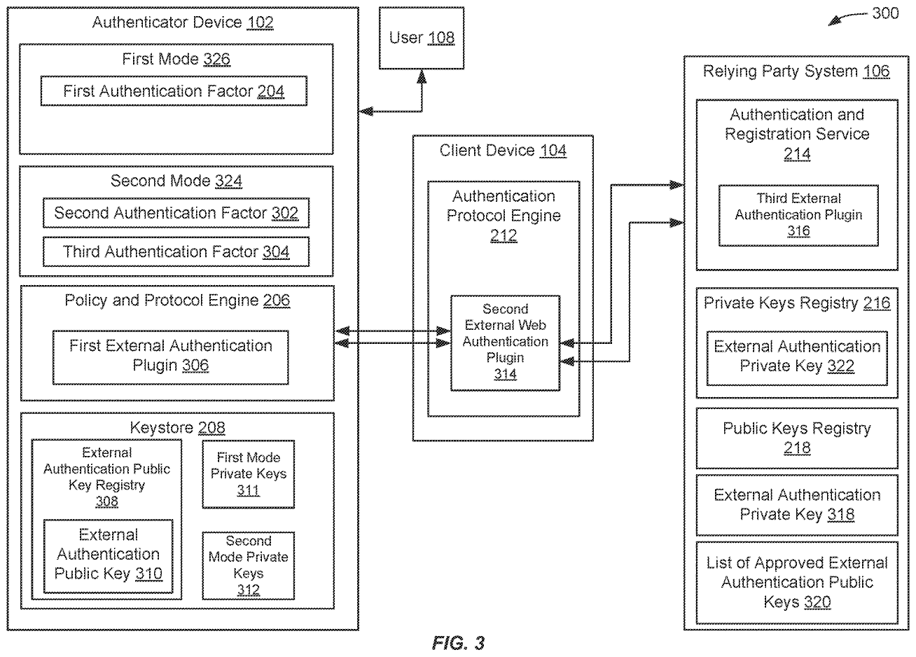

FIG. 3 illustrates a system 300, according to an embodiment. System 300 includes an authenticator device 102, a client device 104, and a relying party system 106 (e.g., which may be the same authenticator device 102, client device 104, and relying party system 106 as described above). The system 300 may be used to cause the authenticator device 102 to perform external authentication of the relying party system 106. The system 300 may be used to cause the authenticator device 102 to manage passkeys associated with respective modes. Private keys of passkeys may be accessed based on which mode is activated.

### A. External Authentication of Relying Party System

As described above (e.g., with respect to system 200), the authenticator device 102 may authenticate a user 108 of the authenticator device 102 and prove the user authentication to the relying party system 106 using a signed response message. Certain embodiments of the present disclosure enable external authentication to be performed. External authentication can enable the authenticator device 102 to authenticate the relying party system 106. External authentication can be used to authenticate the relying party system 106 to the authenticator device 102 before a message (e.g., a signed response message) is sent to the relying party system 106 from the authenticator device 102.

External authentication can be performed using an external authentication key pair. The external authentication key pair may include an external authentication public key 310 and an external authentication private key 322. The external authentication key pair may be generated by the relying party system 106.

The external authentication private key 322 can be accessible to (e.g., stored by) the relying party system 106. The relying party system 106 may manage one or more private keys that it uses as an external authentication private key 322. In certain embodiments, the private keys registry 216 of the relying party system 106 may include one or more external authentication private keys.

The external authentication public key 310 can be stored in a list of approved external authentication public keys 320. The external authentication public key 310 can be transmitted to the authenticator device 102 and stored in the external authentication public key registry 308 of the keystore 208. The external authentication public key registry 308 may include any number of public keys of any number of relying party systems that can be used to perform external authentication with the relying party system 106.

### 1. Acquiring External Authentication Public Keys

External authentication public keys may be transmitted to the authenticator device 102 by the relying party system 106 via the client device 104 at multiple points in time. In an embodiment, the authentication and registrations service 24 causes the external authentication public key 310 (e.g., associated with a signature generated using the external authentication private key 322) of the relying party system 106 to be saved in/imported to the external authentication public key registry 308 of the authenticator device 102. In an embodiment, more than one external authentication public key may be imported to the authenticator device 102. The set of external authentication public keys imported to the device may be included in a list of approved external authentication public keys 320 stored and/or generated by the relying party system 106. In certain embodiments, the external authentication public key 310 may not be transmitted/imported to the authenticator device 102 if the authenticator device 102 includes predefined external authentication public keys.

Importing external authentication public keys to the authenticator device 102 may be performed before the authenticator device 102 is issued, sold, used with a relying party system 106, and/or before access to a resource is requested by a user 108 of the authenticator device 102.

In certain embodiments, multiple versions of the same external authentication public key 310 may be stored in the external authentication public key registry 308 for a single relying party system 106 to allow key rotation (e.g., over time). Key rotation may not be used when the authenticator device 102 is updated prior to executing web authentication being called with the relying party system 106. In certain embodiments, the most up-to-date external authentication public key 310 may be available in both the authenticator device 102 and the authentication and registration service 214.

In certain embodiments, a list of approved external authentication public keys 320 may be imported to the authenticator device 102 along with a corresponding relying party identifier (e.g., domain identifier) and/or version bindings. Registration and/or authentication API calls to the authentication and registration service 214 may cause the list of approved external authentication public keys to 320 to be provided to the authenticator device 102.

Any external authentication public keys and/or corresponding information (e.g., relying party identifier, version bindings) imported to the external authentication public key registry 308 may be signed with the corresponding external authentication private key 322 of the relying party system 106. Thus, the external authentication public keys and/or corresponding information may be verifiable with the relying party system's 106 corresponding external authentication public key 310. In an embodiment, the import of an external authentication public key 310 may fail if the verification fails, or the external authentication public key version is the same or lower than the current key version that corresponds to an existing external authentication public key 310 stored in the external authentication public key registry 308 associated with the same relying party identifier.

In certain embodiments, the external authentication public keys and/or corresponding information imported to the external authentication public key registry 308 may be signed with an external authentication private key 322 of another relying party.

In certain embodiments, after an external authentication public key 310 has been imported to the authenticator device 102, the authenticator device 102 generates the passkey that includes a private key and a public key and transmits the public key to the relying party system 106.

In an embodiment, the authenticator device 102 may be permanently locked on a relying party identifier (e.g., domain identifier) if a relying party system 106 signed a random number with an external authentication public key version number that is higher than a version of the external authentication public key 310 loaded on the authenticator device 102. In an embodiment, a reset or flush mechanism may exist to clear the external authentication public key registry 308, or to disable it forever (e.g., using a signed NULL ‘0x 00 . . . 0’ or ‘0xFF . . . F’ external authentication public key 310).

In an embodiment, the import of external authentication public keys (e.g., signed external authentication public keys) is possible without activating a private key (e.g., included in the first mode private keys 311 or the second mode private keys 312) or prompting an authentication input (e.g., at the beginning of the web authentication registration call).

As mentioned above, the authentication protocol engine 212 may communicate with the authentication and registration service 214 using a web authentication protocol. As mentioned above, the authentication protocol engine 212 may communicate with the policy and protocol engine 206 using CTAP. CTAP and/or web authentication can be used to perform the external authentication. The authenticator device 102 may implement a first external authentication plugin 306 to perform the external authentication with a second external authentication plugin 314 of the authentication protocol engine 212. The second external authentication plugin 314 may perform the external authentication with a third external authentication plugin 316 of the relying party system 106. The second external authentication plugin 314 may be configured to act as a middleman between a CTAP protocol and a web authentication protocol. In an embodiment, if the third external authentication plugin 316 is capable of accessing the external authentication private key 322 of the relying party system 106, the authenticator device 102 can check for a connection during any web authentication API call to the authentication and registration service 214.

### 2. External Authentication Using the External Authentication Public Key

After an external authentication public key 310 of an external authentication key pair has been obtained by the authenticator device 102, the authenticator device 102 can use the external authentication public key 310 to authenticate a signed external authentication message received from the relying party system 106 to check that the signed external authentication message received was signed by the external authentication private key 322 included in the external authentication key pair.

If the authenticator device 102 uses the external authentication public key 310 to determine a signed external authentication message received from the relying party system 106 was signed by the external authentication private key 322 included in the external authentication key pair, the authenticator device 102 can determine that the relying party system 106 is authenticated based on the fact that it has control of the external authentication private key 322 corresponding to the relying party's 106 external authentication key pair.

If external authentication cannot authenticate the relying party system 106, the authenticator device 102 may not prompt the user 108 of the authenticator device 102 to provide one or more authentication inputs. If external authentication cannot authenticate the relying party system 106, the authenticator device 102 may activate a default mode if the default mode is not already activated.

If external authentication authenticates the relying party system 106, the authenticator device 102 may prompt the user 108 of the authenticator device 102 to provide one or more authentication input to be compared with one or more authentication factors (e.g., the first authentication factor, the second authentication factor, etc.). The authentication input, if valid (e.g., sufficiently matching one or more authentication factors), can then cause a private key (e.g., associated with private key identification information and/or the mode) to be accessed and used to sign a response message sent to the relying party system 106. Invalid authentication input can prevent one or more private keys from being accessed and used to sign a response message.

As an example, a user 108 may be accessing a website that they have visited in the past. Thus, the external authentication public key registry 308 may include an external authentication public key 310 of the relying party system 106. The authenticator device 102 may issue a challenge to the relying party system 106 and expects the signature of that challenge with the external authentication private key 322 as a response. In such a scenario, the authentication and registration service 214 of the website may send an external authentication response (e.g., using a web authentication protocol) to the client device 104 (e.g., browser) which sends a corresponding external authentication response (e.g., using CTAP protocol) to the authenticator device's 102 policy and protocol engine 206. In an embodiment, the external authentication response includes the signed challenge (signed by the relying party system's 106 external authentication private key 322). The external authentication response may include a public key identifier, mode identification information, and/or a relying party system identifier (e.g., a uniform resource locator (URL)). The authenticator device's 102 policy and protocol engine 206 may then recognize that the signature of the external authentication response message is valid and therefore the relying party system 106 has been authenticated. As a result of the authentication of the relying party system 106, the authenticator device 102 may prompt the user 108 of the authenticator device 102 to provide one or more authentication input so that the user 108 of the authenticator device 102 can be authenticated to the relying party system 106 using a private key stored in the keystore.

### B. Mode Switching

The authenticator device may include one or more modes. As shown, system 200 includes a first mode 326 and a second mode 324, but other modes are possible. Authentication of a user to the authenticator device 102 while the authenticator device 102 has a mode activated may enable any number of private keys corresponding to the activated mode to be accessed (e.g., accessed for use with signing a message). A mode of the authenticator device 102 may be activated based on one or more authentication input received by the authenticator device and/or based on mode identification information received from the relying party system 106.

The mode being used by the authenticator device 102 may configure the authenticator device 102 to require authentication input different than the authentication input required by authentication factors of any other modes of the authenticator device 102. For example, the first mode 326 may require the first authentication factor 204 (e.g., a first PIN value) to be satisfied. The second mode 324 may require a fourth authentication factor (e.g., a second PIN value) to be satisfied. The example shows that the authentication factor may be specific to the mode.

The mode being used by the authenticator device 102 may configure the authenticator device 102 to require authentication input using a user interface different than the user interface(s) used to receive authentication input required by any other mode of the authenticator device 102. In a second example, the first mode 326 may require the first authentication factor 204 be satisfied using a first user interface (e.g., a touchscreen). The second mode 324 may require the second authentication factor 302 and the third authentication factor 304 be satisfied using one or more user interfaces that are different than the first user interface.

In this manner, some embodiments can provide a server-based controlled method to avoid exposure of user factors when the user conditions are unsafe (e.g., use of enterprise credentials in a private environment) or when it is unnecessary. The authentication server (e.g., the relying party system 106) can control which authenticator private key is used, and therefore which activation policy is required, which affects which PINs, passwords, biometric templates, etc. are used. By the authentication server controlling which activation policy is required, the server may also affect which user interface is used to input authentication input.

Mode identification information from the relying party system 106 may include a relying party system identifier, a mode identifier, a user account identifier, and/or a public key identifier (e.g., the public key included in the passkey, the external authentication public key 310), etc. The relying party system 106 identifier could be a domain name of the relying party system 106, a URL, and/or a public key the relying party system 106 possesses a corresponding private key for (e.g., the external authentication public key 310). The authenticator device 102 can obtain the mode identification information from a challenge message received from the relying party system 106 or an external authentication response message received from the relying party system 106. The mode may be activated based on the relying party system 106 external authentication being successful with the authenticator device 102.

In certain embodiments, the keystore 208 of the authenticator device 102 includes more than one external authentication public key registry 308, so that each corresponds to each relying party system and/or mode. In certain embodiments, the authenticator device 102 includes one external authentication public key registry 308 that includes all the external authentication public keys that correspond to each of the modes and/or relying party systems.

Based on the mode identification information received by the authenticator device 102 from the relying party system 106 (e.g., via the client device 104), the authenticator device 102 may determine a mode to activate. In certain embodiments, the private key to be used for authenticating to the relying party system 106 is determined based on the activated mode of the authenticator device 102 and may be accessible based on authentication of the user 108 according to the authentication factors associated with the activated mode. The private key used for authenticating to the relying party system 106 may not be capable of being accessed within the memory of the authenticator device 102 when the authenticator device 102 does not have the corresponding mode activated. Additionally, the private key may be inaccessible by the authenticator device 102 until the authentication factors associated with the activated mode have been satisfied.

In certain embodiments, the mode identification information (e.g., external authentication of the relying party system) may be used to identify the mode in a table stored by the authenticator device 102. In an example, mode may be associated with a private key in a table stored by the authenticator device 102. Based on the activated mode, one or more authentication factors may be determined and all of the one or more authentication factors or a subset of the one or more authentication factors associated with the mode may be satisfied to cause the private key to be used (e.g., for signing). For example, the authentication factors associated with a particular mode may be determined using a table stored by the authenticator device 102 that includes information representing how an authentication factor relates to one or more modes.

After a mode has been activated and authentication factors satisfied by authentication input, one or more private keys associated with the mode can be used (e.g., to sign the challenge message to provide authentication to the relying party system 106). In certain embodiments, the authenticator device 102 signs the challenge message with mode identification information (e.g., a mode identifier, a certificate for the public key, a FIDO attestation, etc.).

In certain embodiments, after a private key associated with the activated mode is used to sign the challenge message, the authenticator device 102 returns to a default mode. In certain embodiments, the authenticator device 102 is caused to switch to a default mode after at least one of: a predetermined period of time, after a period of inactivity, after external authentication of relying party system 106 fails, and/or after being powered ON. In certain embodiments, the authenticator device 102 remains in the default mode until the mode is changed by the user 108 or based on mode identification information received by the authenticator device 102.

The default mode may be entered when no external authentication has verified the relying party system 106. The default mode may prevent the authenticator device 102 from accessing keys in other modes not associated with the default mode. Prevention and allowing access to private keys stored by the authenticator device 102 may be programmatically enforced such that private keys associated with a mode can only be accessed when the mode is activated. For example, if neither of the first mode 326 and the second mode 324 is the default mode, the authenticator device 102 may not be capable of accessing private keys included in the first mode private keys 311 or the second mode private keys 312 when the authenticator device 102 is in the default mode. In certain embodiments, when in default mode, the authenticator device 102 cannot access any private keys.

In certain embodiments, the user 108 of the authenticator device 102 and/or the relying party system 106 may define which modes and/or authentication input interfaces can be used to perform authentication. A relying party system 106 may specify a mode, authentication input interface(s), and/or authentication factor(s) needed to authenticate the user 108 to the relying party system 106 during the authenticator device 102 registration process. In certain embodiments, a mode may be exclusive to a predefined set of relying party systems.

In certain embodiments, the authentication factors of each mode are independent of the authentication factors for other modes. For example, the authentication factors (e.g., PIN, password, etc.) can be the same or different than the authentication factors (e.g., PIN, password, biometric, etc.) across the modes on the same authenticator device 102. In certain embodiments, the same biometric authentication factor (e.g., face scan value) must be the same value across all modes of the same authenticator device 102 (e.g., the same face is used with the first mode 326 that requires a face scan as is used with a second mode 324 that requires a face scan).

As an example, after a challenge message that includes mode identification information is received from the relying party system 106 (e.g., after external authentication of the relying party system 106), the authenticator device 102 may determine which mode of a first mode 326 and a second mode 324 to be activated. For example, the mode identification information may identify the second mode. Based on the mode, the authentication factors for that mode may be used to authenticate the user 108 of the authenticator device 102. In the example, because the second mode is activated, the second authentication factor 302 and the third authentication factor 304 associated with the second mode 324 may be requested from the user 108 of the authenticator device 102. One, some, or all of the authentication factors associated with the second mode 324 may need to be satisfied using authentication input before a private key from the second mode private keys 312 is used to sign a response message. The private key from the second mode private keys 312 may be identified based on the activated mode and/or the mode identification information. The private key included in the second mode private keys 312 may be used to sign a response message to the relying party system 106 and may cause the relying party system 106 to grant access to a resource to the user 108 or system associated with the authenticator device 102.

### C. Usage Example of Switching Modes Based on External Authentication

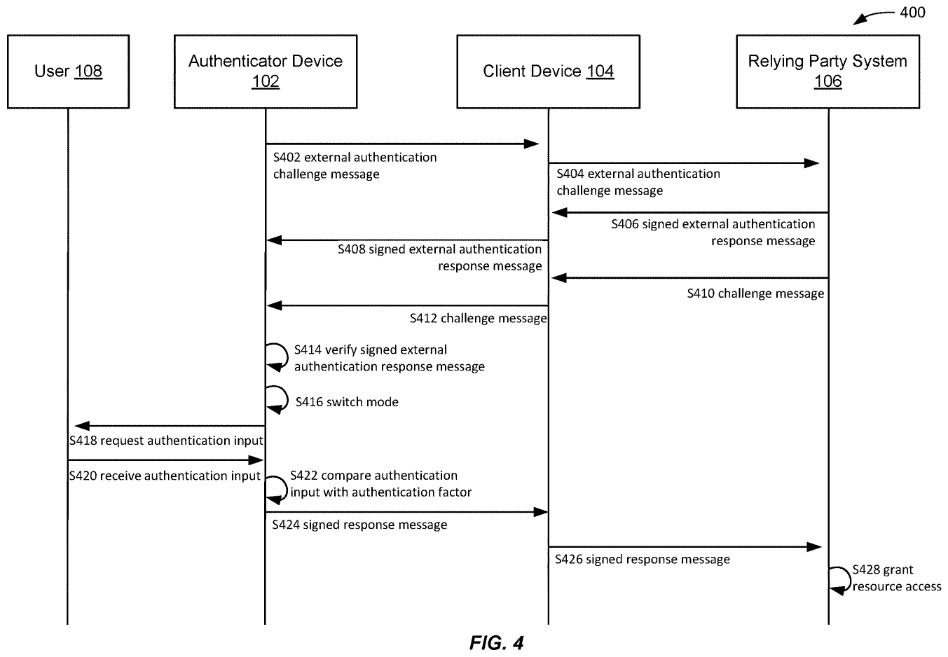

FIG. 4 illustrates a flow diagram 400 where external authentication occurs, according to an embodiment. Flow diagram shows how external authentication of a relying party system 106 can be performed with an authenticator device 102 and that the authenticator device 102 may switch modes based on mode identification information received from the relying party system 106.

At S402, before the authenticator device 102 authenticates itself to a relying party system 106, the authenticator device 102 may request the relying party system 106 authenticate itself to the authenticator device 102. The authenticator device 102 may have access to (e.g., in a keystore) an external authentication public key that corresponds to an external authentication private key of the relying party system 106 and wants to verify that the relying party system 106 has possession of the external authentication private key. The authenticator device 102 may transmit an external authentication challenge message to the client device 104.

At S404, the client device 104 may forward the external authentication challenge message received from the authenticator device 102 to the relying party system 106.

At S406, after receiving the external authentication challenge message, the relying party system 106 may sign an external authentication response message (e.g., including the external authentication challenge message) using the external authentication private key of the relying party system 160. The relying party system 106 may transmit the signed external authentication response message to the client device 104.

At S408, the client device 104 may transmit the signed external authentication response message to the authenticator device 102. The signed external authentication response message may include mode identification information.

At S410, the relying party system 106 may generate and transmit a challenge message to the client device 104. The challenge message may include mode identification information. In certain embodiments, the challenge message may be included in the signed external authentication response message. In certain embodiments, the challenge message can be transmitted before or after the signed external authentication response message. The challenge message may be transmitted to the authenticator device 102 as a result of the relying party system 106 receiving an external authentication challenge message and/or a request to access a resource from the client device 104. The request to access a resource may be included in the external authentication challenge message or another message received from the client device 104. The request to access a resource may be received by the relying party system 106 (e.g., from the client device 104) before, during, or after the external authentication challenge message.

In certain embodiments, the challenge message may be transmitted as a result of the signed external authentication response message being verified by the authenticator device 102 and/or the authenticator device 102 switching modes. The challenge message may be transmitted after a predetermined amount of time has passed since transmitting the external authentication challenge message.

At S412, the client device 104 may transmit the challenge message to the authenticator device 102.

At S414, after the authenticator device 102 receives the signed external authentication response message, the authenticator device 102 may verify that the signed external authentication response message corresponds to the external authentication public key that the authenticator device 102 has stored in an external authentication public key registry of the keystore to determine if the relying party system 106 is authenticated.

At S416, the authenticator device 102 may switch a current mode of the authenticator device 102 if the relying party system 106 is authenticated (e.g., during S414). The authenticator device 102 may switch a current mode of the authenticator device 102 to the mode identified by the mode identification information received from the relying party system 106. The authenticator device 102 may switch from a previously activated mode and/or a default mode. The authenticator device 102 may switch to a first mode (e.g., different from the previously activated mode).

Activation of the mode can cause the authenticator device 102 to prompt a user 108 for authentication, which can cause the authenticator device 102. The mode of the authenticator device 102 can enable the authenticator device 102 to determine which private keys are associated with the mode.

At S418, the authenticator device 102 may prompt/request the user 108 of the authenticator device 102 to input one or more authentication input to authenticate the user 108. The authenticator device may request that the authentication input be received by the authenticator device 102 using a specific user interface (e.g., a microphone, a touchscreen, a keypad, a fingerprint scanner, an optical sensor, etc.).

In certain embodiments, the authenticator device 102 prompts the user 108 of the authenticator device 102 only after the relying party system 106 has been authenticated using external authentication causing a mode to be activated.

At S420, the authenticator device 102 may receive input from the user 108. The input may be authentication input (e.g., a password, a fingerprint, etc.) to be evaluated against one or more authentication factors. The authentication input may be received by the authenticator device 102 using a user interface (e.g., a microphone, a touchscreen, a keypad, a fingerprint scanner, an optical sensor, etc.).

At S422, the authentication input may be compared with one or more authentication factors associated with the mode. The authentication input may satisfy an authentication factor of one or more authentication factors that correspond to the mode, and the mode may be associated with a private key that can be used to authenticate to the relying party system 106.

Each of the one or more authentication factors may be associated with one or more modes. The authentication factors associated with a mode may be defined based on user configurations (e.g., authentication factors set up by the user 108 for the authenticator device 102 or for the mode), the authenticator device 102 user interfaces (e.g., available biometric sensors), or requests from the relying party system 106 (e.g., requests for a certain set of authentication factors to be used, request for a certain authentication input interface to be used, the requests received during the authentication process or before the authentication process (e.g., during enrollment)).

Whether an authentication factor is satisfied may be determined based on the authentication factors associated with a specific mode and the authentication input received from a user 108 of the authenticator device 102.

After user authentication, a private key may be retrieved and used to sign a response message. The private key may correspond to the relying party system 106 and/or a subsystem of the relying party system 106. The private key may be included in a keypair with the public key the relying party system 106 used with the challenge message. The private key may be identified from a set of private keys associated with the mode based on the public key the relying party system 106 used with the challenge message. In certain embodiments, the authenticator device 102 signs the challenge message with mode identification information (e.g., a mode identifier, a certificate for the public key, a FIDO attestation, etc.) and includes the signed challenge message in the signed response message.

The signed response message may be responsive to the challenge message received by the authenticator device 102 as a result of S412. The response message may include a signed challenge message.

At S424, the signed response message may be transmitted to the client device 104. The signed response message may not be sent if the authentication input did not satisfy an authentication factor associated with the active mode. An unsigned response message may be sent to the client device 104 if the authentication input did not satisfy an authentication factor associated with the active mode.

At S426, the signed response message may be transmitted from the client device 104 to the relying party system 106 (e.g., using a wireless connection and/or using a wired connection).

At S428, the relying party system 106 may determine if the signed response message was signed with a private key that corresponds to the public key associated with an account associated with the authenticator device 102. If the signed response message was signed with a private key that corresponds to the public key associated with an account associated with the authenticator device 102, access to one or more resources may be granted to the user 108 or a system associated with the user 108 of the authenticator device 102. If a signed response message is not received from the authenticator device 102, access to one or more resources may be not granted to the user 108 or a system associated with the user 108 of the authenticator device 102.

The ability to switch between authenticator device 102 modes may be useful for preventing a user 108 from using authenticator device 102 authentication factors, private keys, credentials, etc. from being used in a context not controlled by the relying party system 106. The ability to switch between authenticator device 102 modes may be useful for allowing authenticator device 102 users (e.g., employees associated with the relying party system 106) to use their authenticator device 102 from a device (e.g., private computer) that is not controlled and/or approved by the relying party system 106. Such a configuration can prevent authentication factors (e.g., a PIN, credential, etc.) from being exposed to malware (e.g., keylogging malware). Such a configuration can also help prevent the user 108 from exposing a credential (e.g., a private key) to social engineering attacks where the credential may be activated from a link in an email as part of a man-in-the-middle attack. The authenticator device 102 capable of switching modes and performing external authentication can mitigate risk by ensuring that upon power-up, connection, or at boot time, an authenticator device 102 must first authenticate the system or network context before activation of a mode and transmitting a message response signed with a private key.

Further, such system configurations allow for a relying party system 106 to have control over which environments authentication factors, credentials, keys, etc. are used in. A relying party system 106 may prevent the authenticator device 102 from functioning in uncontrolled and/or unauthorized environments, terminals, systems, domains, networks, etc. Further, an embodiment system configuration may allow for a way to authenticate an externally approved context before activating the authenticator device 102 for authentication. The relying party system can also reduce the exposure of biometrics, PINs, and other authentication inputs used for secure (e.g., high risk) transactions and prevent their use in unsecure environments.

The processing depicted in flow diagram 400, and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in flow diagram 400, and described herein are intended to be illustrative and non-limiting. Although flow diagram 400, and other FIGS, describe the various processing steps occurring in a particular sequence or order, this is not intended to be limiting. In certain alternative embodiments, the processing may be performed in some different order or some steps may also be performed in parallel. It should be appreciated that in alternative embodiments the processing depicted in flow diagram 400, and described herein, may include a greater number or a lesser number of steps than those depicted in the respective FIGS.

### IV. Using an Authenticator Device to Provide Security Level Control

As described above, an authenticator device can authenticate a user to a relying party system. In certain embodiments, the relying party system may include subsystems and/or may be included in an overarching system. External authentication and/or mode switching can further enable the authenticator device to authenticate to specific subsystems of an overarching system and provide for security level controls. The ability to control user permissions based on authentication to specific portions of a system can further enhance the confidentiality, availability, and integrity of the resources controlled by the system.

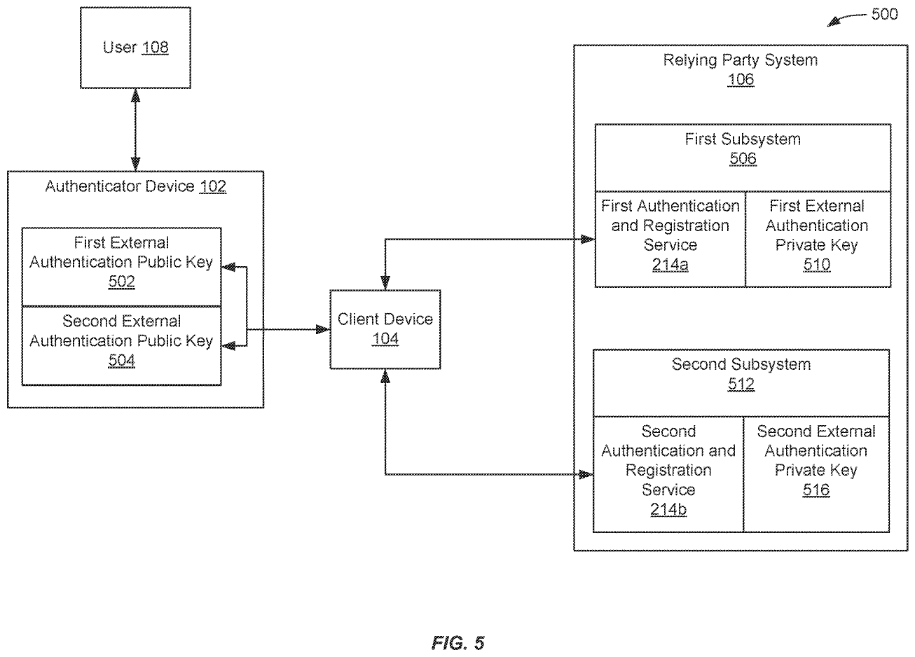

FIG. 5 illustrates a system 500 with security level control, according to an embodiment. System 500 shows how in addition to the authenticator device 102 be capable of being used to perform external authentication for a relying party system 106 and/or provide authentication of an authenticator device user 108 to the relying party system 160, but in certain embodiments, the authenticator device 102 can perform external authentication of a subsystem of the relying party system 106 and/or provide authentication to the subsystem of the relying party system 106.

System 500 illustrates that the authenticator device 102 may be used to externally authenticate a first subsystem 506 of the relying party system 106 using a first external authentication keypair (e.g., the first external authentication private key 510 and the first external authentication public key 502). Additionally, the authenticator device 102 can use a first set of authentication factors (e.g., corresponding to a first mode) to obtain access to a private key used to authenticate the user 108 of the authenticator device 102 to the first subsystem 506.

In certain embodiments, the authenticator device 102 may perform external authentication for the relying party system 106 and/or a specific subsystem (e.g., the first subsystem 506) the authenticator device 102 is in communication with.

For example, the authenticator device 102 may have already externally authenticated the relying party system 106 and authentication has been performed of the user 108 using the authenticator device 102. Subsequently, the user 108 of the authenticator device 102 may request access to a resource managed by the first subsystem 506. The first subsystem 506 can be separately externally authenticated by the authenticator device 102 using a different external authentication keypair as the relying party system 106. Additionally, or alternatively, the user 108 of the authenticator device 102 can be authenticated to the first subsystem 506 using a different passkey than was used to authenticate the user 108 to the relying party system 106. Such controls may assist in giving users with authenticator devices the least privileges necessary and improve system security.

System 500 also shows that the authenticator device 102 may be used to externally authenticate a second subsystem 512 of the relying party system 106 using a second external authentication keypair (e.g., a second external authentication private key 516 and a second external authentication public key 504). Additionally, the authenticator device 102 can use a second set of authentication factors (e.g., corresponding to a second mode) to cause access of a private key that can be used to authenticate the user 108 of the authenticator device 102 to the second subsystem 512.

An authenticator device 102 may be able to switch between modes (e.g., the first mode and the second mode) based on why an authentication of the user 108 is needed. For example, the authenticator device 102 may need to be in the first mode to cause access to be obtained (e.g., by the client device 104 and/or by the authenticator device 102, by the user, etc.) to the first subsystem 506 (e.g., a network or a first domain with the network). In another example, the authenticator device 102 may need to be in a second mode to cause access to be obtained to the second subsystem 512 that is different from the first subsystem 506.

As a further example of the security level control, the relying party system 106 may allow a user's 108 authenticator device 102 to authenticate both to a first authentication and registration service 214a (e.g., a FIDO service) of the first subsystem 506 (e.g., a first domain) of the relying party system 106, and to a second authentication and registration service 214b of the second subsystem 512 (e.g., a second domain) of the relying party system 106. The second subsystem 512 may have a business relationship with the first subsystem 506 and the first subsystem 506 may trust that the second subsystem 512 can protect the authenticator device 102 of the user 108 who also uses the authenticator device 102 to access the first subsystem 506.

During registration to the second subsystem 512 second authentication and registration service 214b (e.g., FIDO backend), the authenticator device 102 may generate a new passkey (e.g., key pair) for that second subsystem 512. If the second subsystem 512 belongs to a domain outside of the first subsystem 506, web authentication of the authenticator device to the second subsystem 512 may not be possible since the second subsystem 512 may not yet have been externally authenticated to the authenticator device 102. A separate second subsystem's 512 second external authentication public key 504 must be registered in the authenticator device 102 so that the external authentication can be performed and cause a mode of the authenticator device 102 to be activated. The second external authentication public key 504 import may need to be authorized (e.g., signed by the first subsystem's 506 first external authentication private key 510) in order for the second external authentication public key 504 relating to the second subsystem 512 to be stored on the authenticator device 102.

### V. Managing Supervised Biometric Authentication Factors of an Authenticator Device

One or more of the authentication factors used by the authenticator device to authenticate a user of the authenticator device and cause a private key stored in the keystore of the authenticator device to be used for signing a response message may be a supervised authentication factor.

A supervised authentication factor may be an authentication factor that is supervised at a time a passkey that includes a public key and a private key is enrolled with the relying party system. For example, when the passkey is generated by the authenticator device and the public key of the passkey is transmitted to the relying party system to be associated with a user account of a user of the authenticator device, the user of the authenticator device may be supervised. Supervising a user of the authenticator device may be performed using an enrollment supervision system. The relying party system may rely on the enrollment supervision system to verify that the passkey associated with the authenticator device has been witnessed to belong to a certain user.

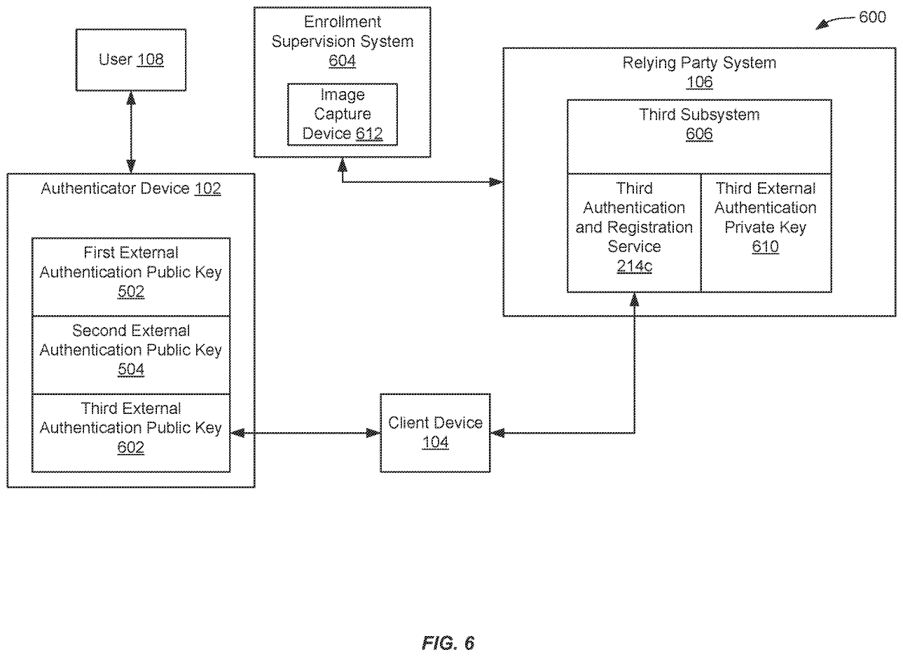

FIG. 6 illustrates a system 600 for supervised authentication factor enrollment, according to an embodiment. System 600 shows how an embodiment may allow for authenticator device 102 supervised biometric authentication factors to be enrolled and/or used.

System 600 includes an enrollment supervision system 604, an authenticator device 102, a client device 104, and a relying party system 106. The authenticator device 102 may have any number of external authentication public keys of any number of relying party systems 106 and/or relying party subsystems in a keystore of the authenticator device 102.

The enrollment supervision system 604 can be used to supervise/monitor at least a portion of enrollment of a biometric authentication factor used by the authenticator device 102 and/or within proximity (e.g., in the same room, in the same building, on the same network) of authentication of the user 108. The enrollment supervision system 604 enables the biometric authentication value to be provably verified. The enrollment supervision system 604 can enable the relying party system to determine that the biometric authentication factor associated with a specific mode of the authenticator device 102 belongs to the user 108 that the relying party system 106 expects the authentication factor to belong to. The relying party system 106 may not have access to the biometric authentication factor data but may determine that when the biometric authentication factor was supervised, the expected legitimate user 108 performed the biometric authentication with the authenticator device 102 and therefore, if the same biometric authentication factor is satisfied in the future by user 108 authentication input, it would necessarily have to be the same legitimate user 108 to satisfy the same biometric authentication factor.

In certain embodiments, supervised biometric authentication data may be enrolled and a specific relying party system 106 external authentication public key is stored in the authenticator device 102 during pre-registration (and may be in addition to one or more other external authentication public keys stored in the authenticator device 102). In an embodiment, when an authenticator device 102 is connected to a trusted supervised network environment (e.g., connected to a particular router), the authenticator device 102 may be supervised by the enrollment supervision system 604 and/or caused to activate a certain mode based on external authentication of the relying party system 106. In certain embodiments, the supervised biometric has been provably verified to be the biometric for the user 108. For example, the image capture device 612 may have captured one or more images of the user 108 providing authentication input to the authenticator device 102 during a current or previous authentication of the user 108 to the authenticator device 102.

The enrollment supervision system 604 may use an image capture device 604 (e.g., a camera or other device capable of capturing one or more images), a voice recorder, an employee (e.g., a security officer), remote human supervision via face identification, automated control using a biometric database, presentation and electronic validation of a tamper-resistant genuine official identity document, and/or another other process for supervising and/or identifying the user 108 of the authenticator device 102. A web authentication API option may be used so the authenticator device 102 can confirm that the relying party system 106 has been authenticated and the authenticator device 102 includes an external authentication public key corresponding to an external authentication private key of the relying party system 106.

If the authenticator device 102 can authenticate the relying party system 106 using external authentication (e.g., via web authentication), the authenticator device 102 may be caused to activate a specific mode. After entering the specific mode, one or more authentication factors may be received by the authenticator device 102 from the user 108 as authentication input during part of an enrollment process. In the specific mode, enrolled biometric data may be tagged as “supervised” when stored in the authenticator device 102 using an enterprise digital signature (e.g., using the third external authentication private key 610 of the third subsystem 606). In an embodiment, biometrics and/or supervised biometrics can only be enrolled when the authenticator device 102 is in a particular mode (e.g., supervised mode). The authenticator device 102 may include a registry of authorized biometric data that has been imported to the authenticator device 102 during supervision with a trusted authorization process.

In an embodiment, a relying party (e.g., the relying party system 106, the third subsystem 606) may require a higher level of security. When the authenticator device 102 requests a web authentication API using an external authentication challenge, the external authentication response from the relying party system 106 may indicate that supervised biometrics are required to authenticate to the domain or network. In an embodiment, the indication of supervised biometric requirements may be part of the signed response (e.g., that includes the challenge from the external authentication challenge message). When such a response occurs, the authenticator device 102 may be set into a high-privileged mode and only able to accept user authentication with authorized biometrics that were previously registered and “tagged” in the authenticator device 102 as “supervised.” In an embodiment, it may be preferable that the biometrics are obtained in a supervised mode. In an embodiment, biometrics tagged as supervised may be used when a mode requires biometrics, but does not require a high security level of biometrics such as supervised biometrics.

In an embodiment, biometrics may be approved and registered into the authenticator device 102 whether or not they are tagged as supervised. Thus, in some modes, the authenticator device 102 may not require that biometrics be verified against previously obtained supervised biometrics. Further, in an embodiment, only signed biometric reference data may be used to authenticate a specific authenticator device 102 (whether or not the biometric reference data is tagged as supervised). In an embodiment, the requirement for biometric authentication does not affect user privacy (e.g., privacy through anonymity). The relying party 106 and/or authenticator device 102 may ensure that a digital identity claim for a period of time is exclusively bound to one user which may thereby allow an enterprise or other relying party to control identities of users interacting with resources. Thus, the relying party 106 may determine whether or not a supervised biometric is required. The binding of an authentication mode to a specific user based on supervised biometric information reduces the risk that an authenticator device 102 can be used by a user who is not an intended user account holder and thereby reduces the risk to the relying party 106 of the authenticator device 102 being used by a user who should not be able to use the authenticator device 102, the authentication factors, keys, and/or credentials obtainable from the authenticator device 102

In an embodiment, the authenticator device 102 may have a mode enabled that does not require the biometric authentication to be supervised or may not require any biometric authentication at all. Further, a biometrics authentication system used to obtain biometric input from the user 108 of the authenticator device may be included in the authenticator device 102 or may be external to the authenticator device 102.

### VI. Computer System

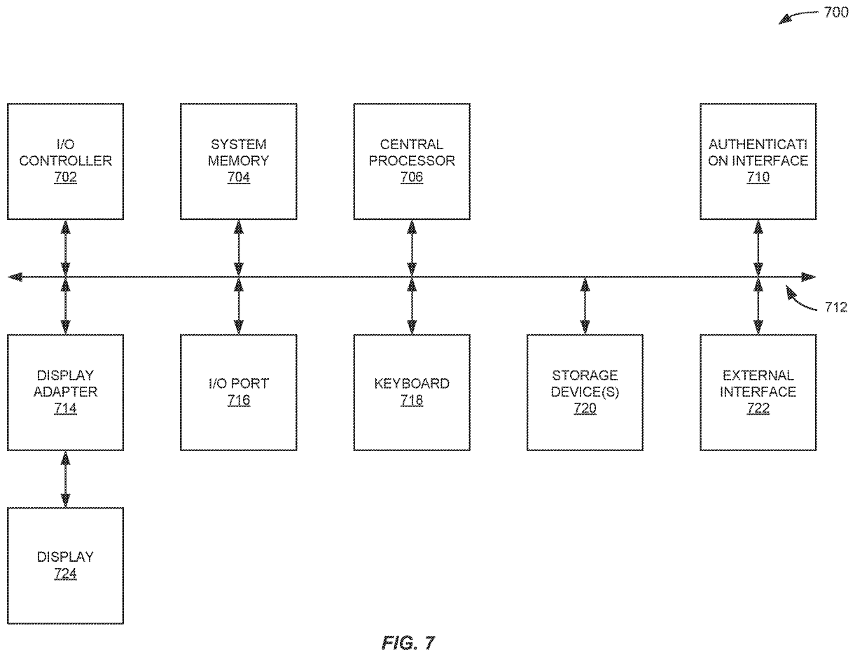

Any of the computer systems mentioned herein may utilize any suitable number of subsystems. Examples of such subsystems are shown in FIG. 7 in computer system 700. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones, and other mobile devices.

The subsystems shown in FIG. 7 are interconnected via a system bus 712. Additional subsystems such as a keyboard 718, storage device(s) 720, a display 724 (e.g., a display screen, such as an LED), which is coupled to display adapter 714, an authentication interface 710, and others are shown. Peripherals and input/output (I/O) devices, which couple to I/O controller 702, can be connected to the computer system by any number of means known in the art such as input/output (I/O) port 716 (e.g., USB, FireWire®). For example, I/O port 716 or external interface 722 (e.g., Ethernet, Wi-Fi, etc.) can be used to connect computer system 700 to a wide area network such as the Internet, a mouse input device, or a scanner. The interconnection via system bus 712 allows the central processor 706 to communicate with each subsystem and to control the execution of a plurality of instructions from system memory 704 or the storage device(s) 720 (e.g., a fixed disk, such as a hard drive, or optical disk), as well as the exchange of information between subsystems. The system memory 704 and/or the storage device(s) 720 may embody a computer readable medium. The authentication interface 710 may include a camera, microphone, accelerometer, and the like. The authentication interface may be used to obtain authentication information from a user (e.g., of an authenticator device). Any of the data mentioned herein can be output from one component to another component and/or can be output to a user.

A computer system can include a plurality of the same components or subsystems, e.g., connected together by external interface 722, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present disclosure can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. The time constraint may be 1 minute, 1 hour, 1 day, or 7 days. Thus, embodiments involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the disclosure. However, other embodiments of the disclosure may involve specific embodiments relating to each individual aspect, or specific combinations of these individual aspects. The above description of exemplary embodiments of the disclosure has been presented for the purpose of illustration and description. It is not intended to be exhaustive or to limit the disclosure to the precise form described, and many modifications and variations are possible in light of the teaching above. The embodiments were chosen and described in order to best explain the principles of the disclosure and its practical applications to thereby enable others skilled in the art to best utilize the disclosure in various embodiments and with various modifications as are suited to the particular use contemplated.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications, and descriptions mentioned above are herein incorporated by reference in their entirety for all purposes. None is admitted to be prior art.

What is claimed is:

1. A method performed by an authenticator device, the method comprising:
transmitting a challenge to a server as part of a request for a service provided by the server;
receiving, a signed response, wherein the signed response was generated using the challenge and is signed with a private key of the server; and
responsive to receiving the signed response, verifying the signed response with a public key corresponding to the private key of the server, the public key corresponding to a first mode of the authenticator device;
responsive to verifying the signed response, switching a current mode of the authenticator device to the first mode corresponding to the public key; and
providing a second request to a user of the authenticator device to authenticate the user using one or more authentication factors corresponding to the first mode.

2. The method of claim 1, wherein the one or more authentication factors comprise at least one of: a PIN, a password, or a biometric.

3. The method of claim 2, wherein the biometric is a supervised biometric that has been verified to be the biometric for the user.

4. The method of claim 3, further comprising:
defining the biometric as the supervised biometric; and
transmitting a second public key corresponding to the supervised biometric to the server.

5. The method of claim 1, wherein the first mode is determined using mode identification information received by the authenticator device from the server.

6. The method of claim 5, wherein the mode identification information includes at least one of: a server identifier, a mode identifier, a user account identifier, or a public key identifier.

7. The method of claim 1, further comprising:
receiving, from a user interface of the authenticator device, an authentication input based on the one or more authentication factors; and
transmitting a second signed response to the server, wherein the second signed response is generated using a second challenge received from the server and is signed with a second private key of the authenticator device.

8. The method of claim 1, further comprising:
after authentication of the user to the authenticator device using the one or more authentication factors and signing a second signed response using a private key of the authenticator device, switching the current mode of the authenticator device from the first mode to a second mode.

9. The method of claim 8, wherein the first mode is associated with a first set of one or more authentication factors and the second mode is associated with a second set of one or more authentication factors.

10. The method of claim 1, wherein the authenticator device remains in the first mode until the authenticator device is powered off.

11. The method of claim 1, further comprising:
responsive to a failure to verify the signed response, keeping the current mode of the authenticator device activated.

12. The method of claim 1, further comprising:
obtaining, after authentication of the user, access to a resource of the service.

13. The method of claim 1, wherein the authenticator device comprises at least one of: a mobile phone, a tablet, a laptop, a desktop computer, a smartwatch, or a universal serial bus (USB) device.

14. The method of claim 1, wherein the signed response includes at least one of: a public key identifier, mode identification information, or a server identifier.

15. An authenticator device comprising:
a processor; and
a computer readable medium comprising code executable by the processor causing the authenticator device to perform a method according to any of the preceding claims.
